(19) United States
(12) Patent Application Publication
(10) Pub. No.: US 2002/0062266 A1
(43) Pub. Date: May 23, 2002

(54) Merchandise-ordering method, system and apparatus

(75) Inventor: Miyoshi Aoki, Tokyo (JP)

Correspondence Address: McDermott, Will & Emery, 600 13th Street, N.W., Washington, DC, 20005-3096, US

(73) Assignee: MITSUBISHI DENKI KABUSHIKI KAISHA

(21) Appl. No.: 09/862,415

(22) Filed: May 23, 2001

(30) Foreign Application Priority Data
Nov. 22, 2000 (JP) 2000-355732

(51) Int. Cl. G06F 17/60

(52) U.S. Cl. 705/27

(57) ABSTRACT

A low-cost merchandise-ordering method, system, and apparatus that allow customers to directly order menu items safely and sanitarily, to avoid mistakes in entering table number information and communications problems in data transmission, and to change menu information easily.

Customers are allowed to directly order menu items at restaurants and the like: they can decide what to order and place orders via pen input by following the instructions displayed on the merchandise-ordering apparatus 5 and reading displayed merchandise information. Besides, table numbers such as 1 can be acquired from a terminal and table-number information file 4 based on identifiers of the merchandise-ordering apparatus 5. Order data is transmitted via cable such as a LAN 15. Since menu information and the like are recorded in a merchandise information file 3, menu information can be modified easily. A general-purpose terminal can be used as the merchandise-ordering apparatus 5.

### BACKGROUND OF THE INVENTION

1. Field of the Invention

The present invention relates to a merchandise-ordering method, system and apparatus. More particularly, it relates to a merchandise-ordering method, system and apparatus for ordering menu items in restaurants and the like.

2. Description of Related Art

When a receptionist or the like takes an order for menu items in restaurants and the like, the portable terminal is carried by the receptionist, waitresses or the like who takes orders from customers and enters order data in the portable terminal. Then the order data entered in the portable terminal is sent to the printer located in the kitchen and printed out. The above order processing system has come into wide use.

With the order processing system described above, when customers who come to the restaurant sit at a table, first a waiter/waitress hands them a menu, and after a while he/she goes to take their orders. However, the time required for customers to decide what to order varies and thus they have not necessarily decided what to order when the waiter/waitress comes to take their orders. Consequently, the customers may feel offended when pressed to decide what to order.

To solve the above problem, apparatuses have been devised that allow customers themselves to place orders directly. For example, the order receiving apparatus disclosed in Japanese Patent Laid-Open No. 4-232592 allows customers to order dishes using a barcode scanner. However, the barcode scanner, which uses a laser beam, can be dangerous if misused by children.

The ordering device disclosed in Japanese Patent Laid-Open No. 7-28886 allows customers to place orders using a dedicated terminal for receiving orders. However, this device has the following problems.

(1) The use of the dedicated terminal makes the cost of the device relatively high.

(2) Menu information, which has been incorporated into a program, is rather difficult to change.

(3) Communications problems tend to occur because radio transmission is used as a means of sending order data from the ordering device to a central device.

(4) Customers, who touch a touch panel, menu buttons, keys, etc. to operate the ordering device, will get their hands soiled, which is unsanitary when they are going to take a meal.

(5) Since table number information is supposed to be entered by customers, inexperienced customers tend to make input errors.

### SUMMARY OF THE INVENTION

The present invention has been made to solve the above problems. An object of the present invention is to provide a low-cost merchandise-ordering method, system, and apparatus that allow customers to directly order menu items safely and sanitarily, avoid mistakes in entering table number information and communications problems in data transmission, and change menu information easily.

According to a first aspect of the present invention, there is provided a merchandise-ordering method for ordering merchandise, comprising the steps of: a read step of reading merchandise information from a merchandise information recording parting part which records merchandise information; a display step of displaying the merchandise information read in the read step on a display of a merchandise-ordering apparatus equipped with general-purpose terminal functions; a write step of writing the merchandise information selected by means of an input part of the merchandise-ordering apparatus from the merchandise information displayed in the display step into a merchandise order recording part together with location information of the merchandise-ordering apparatus; and outputting the merchandise information written into the merchandise order recording part to a cable-connected output device according to the location information.

According to a second aspect of the present invention, there is provided a merchandise-ordering system which comprises a merchandise-ordering apparatus for ordering merchandise, server for processing merchandise orders and output device for outputting information on ordered merchandise, the merchandise-ordering apparatus, the server and the output device are cable-connected, wherein: the server comprises: a merchandise information recording part which records merchandise information; a location information recording part which records the identifiers and location information of merchandise-ordering apparatus; a merchandise order recording part which records the location information of the merchandise-ordering apparatus as well as merchandise information; merchandise information transmission means for sending the merchandise information read from the merchandise information recording part to merchandise-ordering apparatus; write means for writing the location information of merchandise-ordering apparatus and the merchandise information received from the merchandise-ordering apparatus into the merchandise order recording part; and output information transmission means for sending the merchandise information to the output device according to the location information read from the merchandise information recording part; and the merchandise-ordering apparatus comprises: display means for displaying the merchandise information sent by the merchandise information transmission means on the display of the merchandise-ordering apparatus; and selection information transmission means for sending, to the server, the merchandise information selected by means of the input part of the merchandise-ordering apparatus from the merchandise information displayed by the display means as well as the identifier of the merchandise-ordering apparatus.

According to a third aspect of the present invention, there is provided a merchandise-ordering apparatus equipped with general-purpose terminal functions and used for ordering merchandise, comprising: display means for displaying the merchandise information received from a cable-connected server on the display of the merchandise-ordering apparatus; and selected merchandise transmission means for sending, to the server, the merchandise information selected by means of the input part of the merchandise-ordering apparatus from the merchandise information displayed by the display means as well as the identifier of the merchandise-ordering apparatus; wherein the input part accepts touch input on the display.

The above and other objects, effects, features and advantages of the present invention will become more apparent from the following description of the embodiments thereof taken in conjunction with the accompanying drawings.

### BRIEF DESCRIPTION OF THE DRAWINGS

FIG. 1 shows the general configuration of the merchandise-ordering system according to one embodiment of the present invention.

FIG. 2 is a flowchart of the merchandise-ordering method according to one embodiment of the present invention.

### DETAILED DESCRIPTION OF THE PREFERRED EMBODIMENTS

Preferred embodiments of the present invention will be described in detail below with reference to the accompanying drawings.

Embodiment

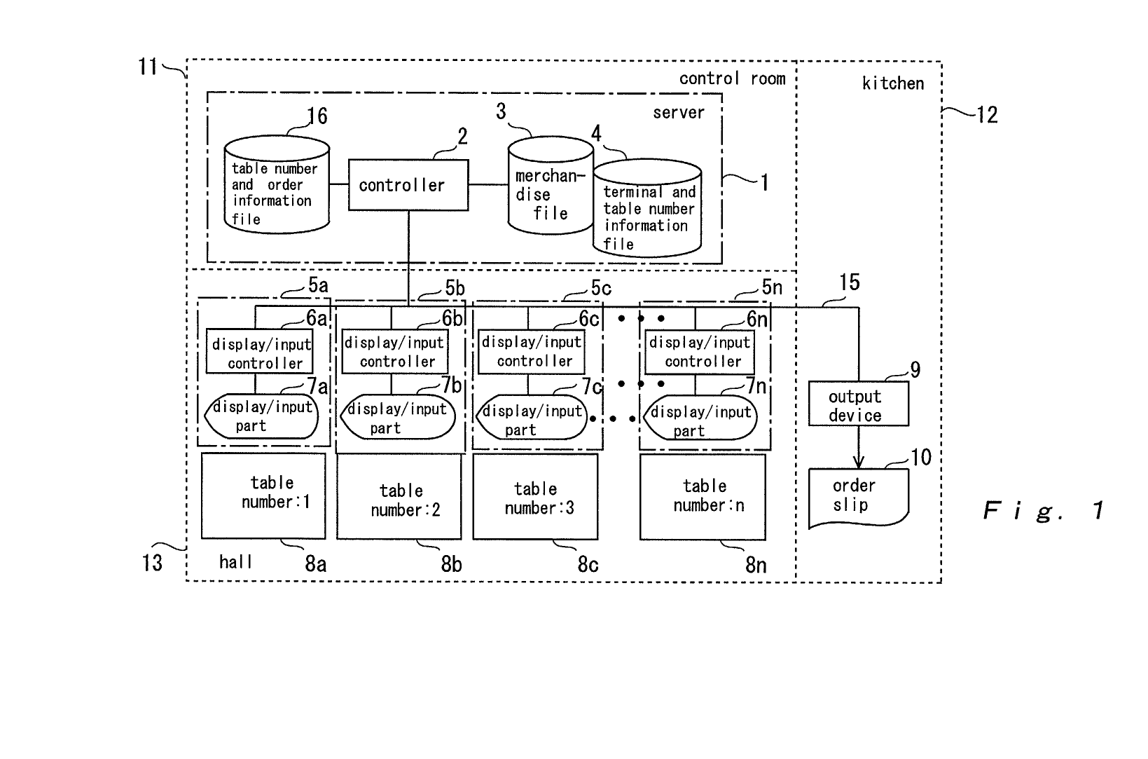

FIG. 1 shows the general configuration of the merchandise-ordering system according to one embodiment of the present invention. In FIG. 1, reference numeral 11 denotes a control room where a server 1 described later is installed, 12 denotes a kitchen, and 13 denotes a hall where tables and the like for customers are installed. The server 1 comprises a controller 2 which consists of a CPU and controls the merchandise-ordering method of the present invention, a merchandise information file (merchandise information recording part) 3 which records the menu items (merchandise information) of the restaurant or the like, terminal and table-number information file (location information recording part) 4 which records the identifiers of merchandise-ordering apparatus 5 described later and location information including the table numbers of the tables where the merchandise-ordering apparatus 5 are installed, and a table number and order information file (merchandise order recording part) 16 which records information on the merchandise ordered via the merchandise-ordering apparatus 5 and corresponding location information including the table numbers.

At the hall 13, reference numerals 8a, 8b, 8c, . . . , 8n (hereinafter generally referred to as “8”) denote the tables which customers sit at. They are assigned table numbers (identifiers) 1, 2, 3, . . . , n (hereinafter referred to as “the table number such as 1”). Reference numerals 5a, 5b, 5c, . . . , 5n (hereinafter generally referred to as “6”) denote merchandise-ordering apparatus installed on the respective tables 8. The merchandise-ordering apparatus 5 is preferably a pen-input notebook computer, but is not limited to that. It can be any device as long as it has general-purpose terminal functions and accepts touch input on the display (7 described later) or the like. Reference numerals 7a, 7b, 7c, . . . , 7n (hereinafter generally referred to as “7”) denote displays or input parts, such as pens, of the merchandise-ordering apparatus 5 while reference numerals 6a, 6b, 6c, . . . , 6n (hereinafter generally referred to as “6”) denote display/input controllers which control the displays/input parts 7. The displays/input parts 7 display merchandise information such as menu items and allow customers to select (enter) merchandise through pen input on touch screen.

At the kitchen 12, reference numeral 9 denotes an output device such as a printer and 10 denotes an order slip outputted from the printer 9. The order slip 10 lists ordered merchandise for each table 8. The server 1, merchandise-ordering apparatus 5, and output device 9 described above are connected through a LAN 15 or hard-wired otherwise.

Now the operation of the merchandise-ordering system will be described. As shown in FIG. 1, first the server 1 reads out merchandise information from the merchandise information file 3 and sends it to the display/input controllers 6 through the LAN 15 or the like (merchandise information transmission means). The transmitted merchandise information is displayed on the displays/input parts 7 (display means). The customer who sits at each table faces the interactive merchandise-ordering apparatus 5, decides what to order by reading the displayed merchandise information (menu item information), and enters data via the input part 7. The display part 7 also displays a series of operations regarding selection of the merchandise information or the like. The merchandise information selected (entered) by means of the display/input part 7 is transmitted by the display/input controller 6, together with the identifier (for example, a serial number) of the merchandise-ordering apparatus 5, to the controller 2 via the LAN 15 or the like (selection information transmission means). The controller 2 searches the terminal and table-number information file 4 using the received identifier to retrieve the table 8 that corresponds to the received identifier (location information acquisition means). Next, the system performs order processing: it records the retrieved table number such as 1 and transmitted merchandise information as a pair in the table number and order information file 16 (write means). The controller 2 transmits the merchandise information of each table 8 recorded in the table number and order information file 16 to the output device 9 installed in the kitchen 12 via the LAN 15 or the like (output information transmission means). The transmitted merchandise information for each table 8 is outputted as an order slip 10.

Needless to say, the contents of the merchandise information file 3 can be updated as required after any changes to the contents of the menu provided. Therefore, menu information can be changed easily.

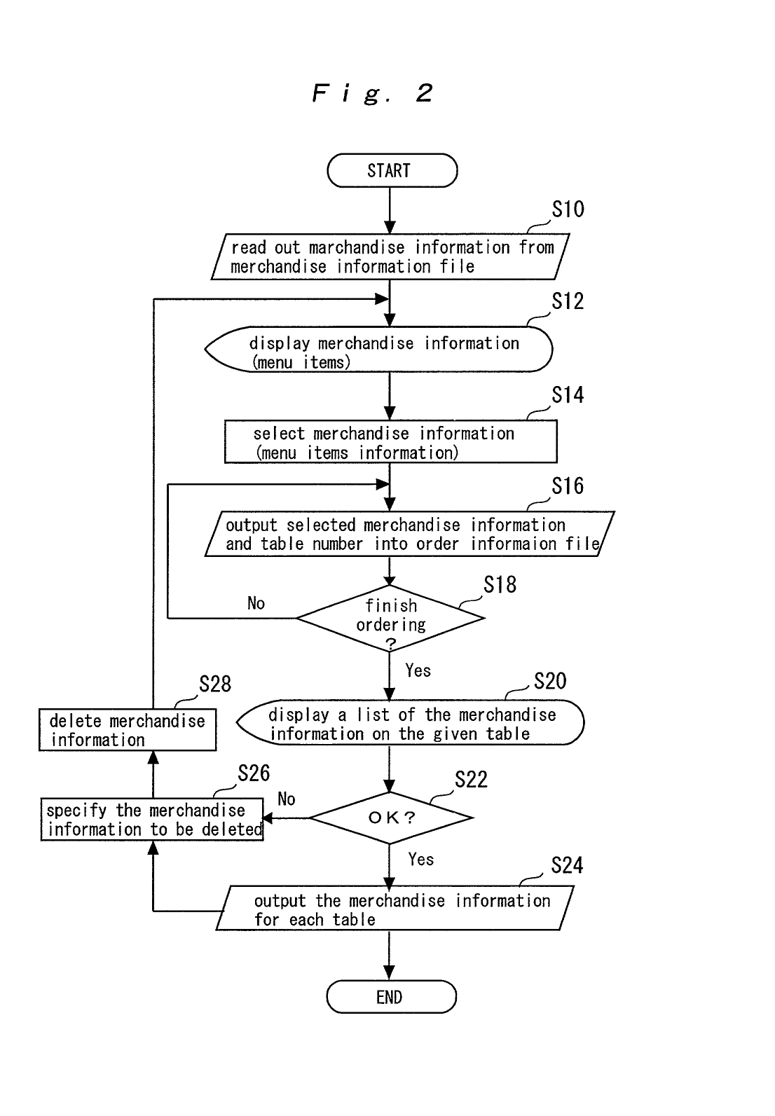

FIG. 2 is a flowchart of the merchandise-ordering method according to one embodiment of the present invention. As shown in FIG. 2, merchandise information is read out from the merchandise information file 3 first (Step S10: read step), the merchandise information read out is displayed on the display 7 of the merchandise-ordering apparatus 5 (Step S12: display step). The customer selects merchandise from the displayed merchandise information through touch-pen input using the input part 7 of the merchandise-ordering apparatus 5 (Step S14). The merchandise information selected by the customer is written, together with the table number, such as 1, of the table on which the merchandise-ordering apparatus 5 is located, into the table number and order information file 16 (Step S16: write step). The customer selects merchandise a desired number of times and Step S16 is repeated until the customer finishes ordering. When the customer finishes ordering by selecting the “Finish Ordering” button displayed on the display 7, a list of merchandise ordered on the given table 8 is displayed on the display 7 of the merchandise-ordering apparatus 5 (Step S20: merchandise listing step). If the customer confirms the list of ordered merchandise (Step S22) by selecting “OK,” the merchandise information written in the table number and order information file 16 is outputted to the outputted device 9 for each table 8 via the LAN 15 or the like (Step S24). If the customer does not give OK in Step S22, the merchandise information selected or specified by means of the input part 7 of the merchandise-ordering apparatus 5 from the list of merchandise information displayed in said merchandise listing step S20 is deleted from the table number and order information file 16 (Steps S26 and S28). Then the process is repeated from Step S12 (display step).

Step S16 (write step) described above can be performed as follows. First, the identifier of the merchandise-ordering apparatus 5 is acquired (identifier acquisition step) together with the merchandise information selected by means of the input part 7 of the merchandise-ordering apparatus 5 from the merchandise information displayed in Step 12 (display step). Next, location information including the table number, such as 1, of the table which corresponds to the identifier acquired in the identifier acquisition step is acquired (location information acquisition step) from the terminal and table-number information file 4 which records the identifiers of the merchandise-ordering apparatus 5 and location information including the table numbers, such as 1, of the tables where the merchandise-ordering apparatus 5 are installed. Finally, the write step is performed: the merchandise information acquired in the identifier acquisition step and the location information acquired in the location information acquisition step are written into the table number and order information file 16.

Thus, the embodiment described above allows customers to directly order menu items at restaurants and the like: they can decide what to order and place orders via pen input by following the instructions displayed on the merchandise-ordering apparatus 5 and reading displayed merchandise information (menu item information). Consequently, the customers can perform input operations safely and sanitarily. Besides, since table numbers such as 1 can be acquired from the terminal and table-number information file 4 based on the identifiers of the merchandise-ordering apparatus 5, mistakes can be avoided in entering table number information. Order data is transmitted via cable such as the LAN 15, making it possible to avoid communications problems in the transmission of the order data. Since menu information and the like are recorded in the merchandise information file 3, the menu information can be modified easily. Furthermore, a general-purpose terminal can be used as the merchandise-ordering apparatus 5, providing a low-cost merchandise-ordering apparatus, system, etc.

As described above the merchandise-ordering method, system, and apparatus according to the present invention allow customers to directly order menu items at restaurants and the like safely and sanitarily by selecting them from displayed merchandise information via pen input. Besides, since table numbers such as 1 can be acquired from the terminal and table-number information file 4, mistakes can be avoided in entering table number information. Order data is transmitted via cable such as the LAN 15, making it possible to avoid communications problems in the transmission of the order data. Since menu information and the like are recorded in the merchandise information file 3, the menu information can be modified easily. Furthermore, a general-purpose terminal can be used as the merchandise-ordering apparatus 5, providing a low-cost merchandise-ordering apparatus, system, and method.

The present invention has been described in detail with respect to various embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

In the merchandise-ordering method, the write step may comprise the steps of: an identifier acquisition step of acquiring the identifier of the merchandise-ordering apparatus together with the merchandise information selected by means of the input part of the merchandise-ordering apparatus from the merchandise information displayed in the display step; a location information acquisition step of acquiring location information corresponding to the identifier acquired in the identifier acquisition step, from a location information recording part which records the identifiers and location information of merchandise-ordering apparatus; and writing the merchandise information acquired in the identifier acquisition step and the location information acquired in the location information acquisition step into the merchandise order recording part.

In the merchandise-ordering method, the write step may be followed by the steps of: a merchandise listing step of displaying a list of the merchandise information written in the write step on the display of the merchandise-ordering apparatus; and deleting, from the merchandise order recording part, a predetermined merchandise information selected by means of the input part of the merchandise-ordering apparatus from the list of the merchandise information displayed in the merchandise listing step.

In the merchandise-ordering method, the input part may accept touch input on the display.

In the merchandise-ordering method, the merchandise-ordering apparatus may be portable and the input part may use pen input.

In the merchandise-ordering system, the write means comprises: location information acquisition means for acquiring location information corresponding to the identifier received from the merchandise-ordering apparatus, from the location information recording part; and means for writing the merchandise information received from the merchandise-ordering apparatus and the location information acquired by the location information acquisition means into the merchandise order recording part.

The entire disclosure of Japanese Patent Application No. 2000-355732 filed on Nov. 22, 2000 including specification, claims, drawings and summary are incorporated herein by reference in its entirety.

What is claimed is:

1. A merchandise-ordering method for ordering merchandise, comprising the steps of:
a read step of reading merchandise information from a merchandise information recording parting part which records merchandise information;
a display step of displaying the merchandise information read in said read step on a display of a merchandise-ordering apparatus equipped with general-purpose terminal functions;
a write step of writing the merchandise information selected by means of an input part of the merchandise-ordering apparatus from the merchandise information displayed in said display step into a merchandise order recording part together with location information of the merchandise-ordering apparatus; and
outputting the merchandise information written into the merchandise order recording part to a cable-connected output device according to the location information.

2. The merchandise-ordering method according to claim 1, wherein said write step comprises the steps of:
an identifier acquisition step of acquiring the identifier of the merchandise-ordering apparatus together with the merchandise information selected by means of the input part of the merchandise-ordering apparatus from the merchandise information displayed in said display step;
a location information acquisition step of acquiring location information corresponding to the identifier acquired in said identifier acquisition step, from a location information recording part which records the identifiers and location information of merchandise-ordering apparatus; and
writing the merchandise information acquired in said identifier acquisition step and the location information acquired in said location information acquisition step into the merchandise order recording part.

3. The merchandise-ordering method according to claim 2, wherein said write step is followed by the steps of:
a merchandise listing step of displaying a list of the merchandise information written in said write step on the display of the merchandise-ordering apparatus; and
deleting, from the merchandise order recording part, a predetermined merchandise information selected by means of the input part of the merchandise-ordering apparatus from the list of the merchandise information displayed in said merchandise listing step.

4. The merchandise-ordering method according to claim 3, wherein said input part accepts touch input on the display.

5. The merchandise-ordering method according to claim 4, wherein said merchandise-ordering apparatus is portable and said input part uses pen input.

6. The merchandise-ordering method according to claim 2, wherein said input part accepts touch input on the display.

7. The merchandise-ordering method according to claim 6, wherein said merchandise-ordering apparatus is portable and said input part uses pen input.

8. The merchandise-ordering method according to claim 1, wherein said write step is followed by the steps of:
a merchandise listing step of displaying a list of the merchandise information written in said write step on the display of the merchandise-ordering apparatus; and
deleting, from the merchandise order recording part, a predetermined merchandise information selected by means of the input part of the merchandise-ordering apparatus from the list of the merchandise information displayed in said merchandise listing step.

9. The merchandise-ordering method according to claim 8, wherein said input part accepts touch input on the display.

10. The merchandise-ordering method according to claim 9, wherein said merchandise-ordering apparatus is portable and said input part uses pen input.

11. The merchandise-ordering method according to claim 1, wherein said input part accepts touch input on the display.

12. The merchandise-ordering method according to claim 11, wherein said merchandise-ordering apparatus is portable and said input part uses pen input.

13. A merchandise-ordering system which comprises a merchandise-ordering apparatus for ordering merchandise, server for processing merchandise orders and output device for outputting information on ordered merchandise, the merchandise-ordering apparatus, the server and the output device are cable-connected, wherein:
said server comprises:
a merchandise information recording part which records merchandise information;
a location information recording part which records the identifiers and location information of merchandise-ordering apparatus;
a merchandise order recording part which records the location information of the merchandise-ordering apparatus as well as merchandise information;
merchandise information transmission means for sending the merchandise information read from said merchandise information recording part to merchandise-ordering apparatus;
write means for writing the location information of merchandise-ordering apparatus and the merchandise information received from the merchandise-ordering apparatus into the merchandise order recording part; and
output information transmission means for sending the merchandise information to the output device according to the location information read from said merchandise information recording part; and
said merchandise-ordering apparatus comprises:
display means for displaying the merchandise information sent by said merchandise information transmission means on the display of the merchandise-ordering apparatus; and
selection information transmission means for sending, to the server, the merchandise information selected by means of the input part of the merchandise-ordering apparatus from the merchandise information displayed by said display means as well as the identifier of the merchandise-ordering apparatus.

14. The merchandise-ordering system according to claim 13, wherein said write means comprises:
location information acquisition means for acquiring location information corresponding to the identifier received from said merchandise-ordering apparatus, from the location information recording part; and
means for writing the merchandise information received from said merchandise-ordering apparatus and the location information acquired by said location information acquisition means into the merchandise order recording part.

15. A merchandise-ordering apparatus equipped with general-purpose terminal functions and used for ordering merchandise, comprising:
display means for displaying the merchandise information received from a cable-connected server on the display of the merchandise-ordering apparatus; and
selected merchandise transmission means for sending, to the server, the merchandise information selected by means of the input part of the merchandise-ordering apparatus from the merchandise information displayed by said display means as well as the identifier of the merchandise-ordering apparatus;
wherein said input part accepts touch input on the display.
